(19) United States
(12) Patent Application Publication
(10) Pub. No.: US 2006/0070754 A1
(43) Pub. Date: Apr. 6, 2006

(54) Steerable attachment for equipment

(76) Inventors: C. Christopher Zanetis, Brownsburg, IN (US); Joel J. Nicoson, Cory, IN (US)

Correspondence Address: BAKER & DANIELS LLP, 300 NORTH MERIDIAN STREET, SUITE 2700, INDIANAPOLIS, IN, 46204, US

(21) Appl. No.: 11/241,531

(22) Filed: Sep. 30, 2005

Related U.S. Application Data
(60) Provisional application No. 60/615,145, filed on Oct. 1, 2004.

(51) Int. Cl. A01B 59/043

(52) U.S. Cl. 172/47

(57) ABSTRACT

The present invention involves a locating apparatus which is detachably mountable to a self-propelled vehicle. The vehicle has a pair of opposing lift arms each outwardly adjacent to the sides of the vehicle. The lift arms may be swingable up and down in unison and projecting forward to have front ends in front of a front end of the vehicle. Each of the lift arms has an attachment mechanism that provides for removable mounting of the apparatus to the arms. The vehicle has wheels capable of turning within a turning radius. The locating apparatus has a frame with means for attaching the apparatus to the lift arms; The holder is adapted to support a work implement over a work surface. The attachment has a mechanism that shifts the angular position of the holder and work implement with respect to the frame members so that the holder and work implement may be positioned in a plurality of directions parallel to radii of the turning radius. The holder is adapted to support a variety of implements such as a cold planner, a rock wheel, or a trencher. The frame has an arched surface, and the holder has a surface corresponding to the arched surface of the frame. The shifting mechanism is configured to shift angular position in conjunction with turning of the wheels.

### BACKGROUND OF THE INVENTION

1. Field of the Invention

The present invention relates to attachments for rotary apparatus, such as a cold planer or a rock wheel, for vehicles such at a front loader. Specifically, the invention pertains to attachments allowing the moveable positioning of the rotary apparatus.

2. Description of the Related Art.

Several detachable rotary devices, such as cold pavement planers and rock wheels, are available for attachment to vehicles such as front end loaders. The detachablility of these devices from a vehicle has made them very cost effective since many other types of attachments may be mounted on the same vehicle. However, it is often difficult to use a cold planer or rock wheel in restricted conditions.

One prior device involves an apparatus including opposing first and second frame members and a rotary work implement having front and rear peripheries and left and right peripheries. The rotary apparatus provides a mechanism for supporting the work implement from the first and second frame members such that the front, rear, left and right peripheries may extend beyond the fronts of the frame members. The mechanism shifts the position of the work implement in a direction parallel to a line between the first and second frame members, such that either one of the peripheries of the work implement may extend beyond the side edge of the first frame member. The capability to shift the work implement beyond the sides of the frame members allows the apparatus to be used to horizontally plane adjacent a vertical wall or obstruction, such as a curb.

### SUMMARY OF THE INVENTION

The present invention involves a steerable attachment mechanism that allows pivoting of the rotary device relative to the vehicle. For a front end loader, the attachment mounts on the lift arms of the loader and allows the rotary device to have an adjustable angular orientation relative to the lift arms and the vehicle. This allows the rotary device to be positioned appropriately to the direction of travel when the vehicle is turning, for example to work on a curve in a road.

The attachment provides for the rotary device to be positioned along an arc of a frame connected to the vehicle, namely the lift arms. Hydraulics or other motive force may position the rotary device in one of several possible angular orientations by sliding the rotary device along the arc of the frame.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a top plan view of the present invention showing the rotary device in several angular positions.

FIG. 2 is a side view taken along view lines 2-2 of FIG. 1.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiments disclosed below is/are not intended to be exhaustive or limit the invention to the precise form disclosed in the following detailed description. Rather, the embodiment is chosen and described so that others skilled in the art may utilize its teachings.

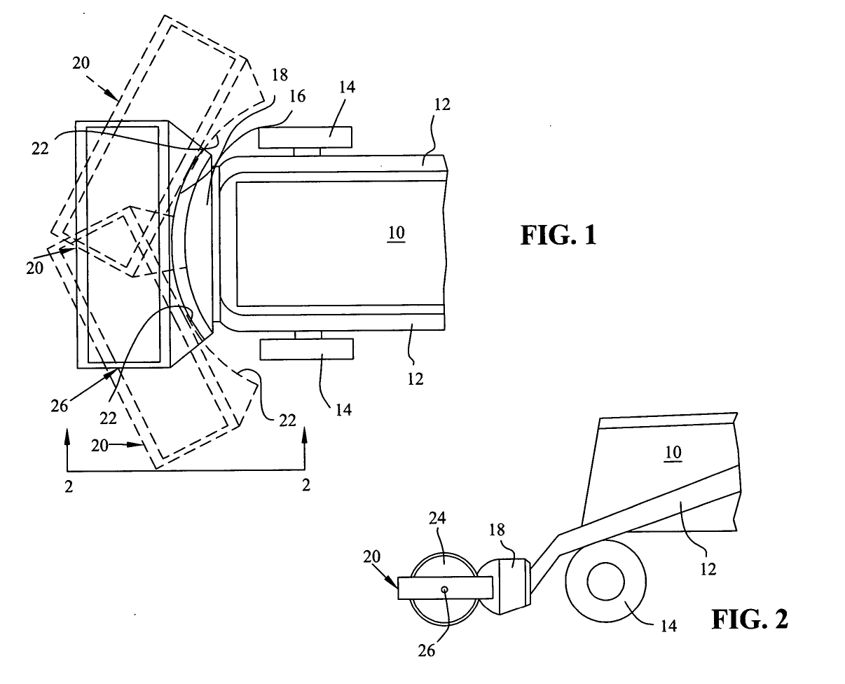

FIG. 1 generally shows front end loader 10 with lifting arms 12 and wheels 14. Attachment frame 16 is coupled to lifting arms 12 and has a generally arc shaped sliding surface 18. Rotary device holder 20 has a pivoting surface 22 that mates with sliding surface 18 to allow the positioning of rotary device holder 20 in several different angular orientations in relation to lift arms 12 (see alternate positions of rotary device holder 20 in the dotted lines). Rotary device 24 may be a cold planner, rock wheel, vibratory roller, or similar implement that has axial support 26 mounted in holder 20. Attachment frame 16 may have driving elements (not shown) that moves holder 20 across sliding surface 18, and such driving elements may be operated in conjunction with or independent of wheels 14.

Although not shown on the drawings, the movement of holder 20 relative to attachment frame 16 may be one of many known driving elements. For example, a hydraulic cylinder supported on one of attachment frame 16 or holder 20 may have a movable rod attached to the other to impart the arc-wise motion. Alternatively, one of attachment frame 16 or holder 20 may have a hydraulic motor that drives a gear which is engaged with a track on the other. These and other known mechanisms may provide the driving elements for moving holder 20 relative to attachment frame 16.

With rotary device 24 moveably mounted on loader 10, it may be positioned at an angle to the direction of loader while maintaining a generally perpendicular orientation relative to the direction of travel of loader 10. If rotary device 24 is positioned askew of the direction of motion of loader 10, the driving force on the pavement is reduced because of the angle and the irregular application of force. It is also possible, with an extreme angle, to upset the balance of loader 10. In order to make the most effective use of rotary device 24, it should be positioned relatively parallel to the direction of motion of loader 10. In particular circumstances where the room for movement of loader 10 is constrained, a small angular adjustment of attachment frame 16 and holder 20 may eliminate multiple back and forth positioning of loader 10.

While the disclosed embodiment shows the use of attachment frame 16 with rotary implements such as cold planers and rock wheels, other types of pavement working implements may also be advantageously used with the present invention. For example, holder 20 may be configured to position trencher type devices at the front of loader 10. This allows holder 20 and the associated trencher to be angularly disposed to be skid steered to follow a curved trench, using a conventional front end loader rather than a more specialized skid steer vehicle. An additional enhancement involves adding vibratory rollers that are left engaged, resulting in the rollers compacting while turning thereby increasing productivity and maneuverability. The present invention thus may allow a skid steer and attachment to simulate the operation of an articulated loader operation which has the advantage of not skidding during turning.

In addition to rotary and trencher devices, holder 20 may be configured to accommodate other implements or equipment such as: angle brooms; augers; buckets; scrappers; snow moving implements; blades and breakers; cutters and chippers; concrete mixers, cutters, and pumps; grapples; and pallet forks.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A locating apparatus detachably mountable to a self-propelled vehicle, the vehicle comprising a pair of opposing lift arms each outwardly adjacent to one of a pair of opposite sides of the vehicle, said lift arms being swingable up and down in unison and projecting forward to have front ends in front of a front end of the vehicle, and each of the lift arms comprising attachment means providing for removable mounting of the apparatus to the arms, the vehicle having wheels capable of turning within a turning radius, the locating apparatus comprising:
a frame with means for attaching the apparatus to the lift arms;
a holder adapted to support a work implement over a work surface; and
means for shifting the angular position of the holder and work implement with respect to the frame members so that the holder and work implement may be positioned in a plurality of directions parallel to radii of the turning radius.

2. The locating apparatus of claim 1 wherein the holder is adapted to support one of a cold planer, a rock wheel, a vibratory roller, and a trencher.

3. The locating apparatus of claim 1 wherein the frame has an arched surface.

4. The locating apparatus of claim 3 wherein the holder has a surface corresponding to the arched surface of the frame.

5. The locating apparatus of claim 1 wherein the shifting means is configured to shift angular position in conjunction with turning of the wheels.
